(19) United States
(12) Patent Application Publication
(10) Pub. No.: US 2020/0208463 A1
(43) Pub. Date: Jul. 2, 2020

(54) Universal Storm Protection Mounting Bracket

(71) Applicants: Noel F. Mascarenhas, Houston, TX (US); Manjunath Mavinakere, Houston, TX (US)

(72) Inventors: Noel F. Mascarenhas, Houston, TX (US); Manjunath Mavinakere, Houston, TX (US)

(21) Appl. No.: 16/702,845

(22) Filed: Dec. 4, 2019

Related U.S. Application Data
(60) Provisional application No. 62/785,160, filed on Dec. 26, 2018.

(51) Int. Cl. E06B 9/00; F16B 2/24

(52) U.S. Cl. CPC E06B 9/00; E06B 2009/005; F16B 2/245

(57) ABSTRACT

An apparatus and system for removably restraining a panel in a structure opening. The apparatus being independent of panel thickness, and requiring no modification of the opening, preserving the contacted surfaces against significant defacing or marring.

### CROSS-REFERENCE TO RELATED APPLICATIONS

This application claims priority under 35 U.S.C. § 119(e) from co-pending U.S. Provisional Patent Application No. 62/785,160, by Mascarenhas, Noel F. & Mavinakere, Manjunath, “Universal Window Protection Mounting Bracket” filed 26 Dec.2018, which, by this statement, is incorporated herein by reference for all purposes.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The invention relates generally to brackets, stands, and supports. More particularly, the invention relates to a bracket for temporarily securing panel materials in a recessed opening of a structure wall to protect a window or door during strong storms.

### Background of the Invention

When anticipating high-wind storms and/or hurricanes, it is common to cover opening for doors and windows of a structure in an effort to reduce damage. Debris blown by high winds can breach openings, not only shattering glass and destroying windows/doors themselves, but also allowing wind and water to enter the structure further increasing damage.

A common preventative effort involves blocking or boarding up door and window opening. This action itself creates damage that must be repaired once the storm subsides. If done incorrectly, screw or nail holes continue to allow moisture penetration, causing trouble long after a storm has passed.

The proper action is to fill the holes, and re-caulk, or re-paint to create a new moisture barrier. This is a costly and extensive effort which may prove ineffective at preventing damage if any holes are overlooked in the process.

Non-intrusive options are far more desirable for protecting openings of homes and businesses during windstorms and hurricanes. There is also the reality that storing materials between events can be a problem for those who do not regularly experience the threat of violent storms.

Locating the materials for making close-fitting panels for each window may be a problem if an impending storm makes plywood difficult to locate. Varying opening sizes allows different thicknesses to sufficiently protect from impact of objects and can also save in material cost.

There are currently custom fit brackets for the specific thickness of a panel, typically ½″, ⅝″ or ¾″ thick. But this requires the building owner to pick the correct bracket for each thickness of panel selected.

Sometimes a specific panel may be thicker or thinner than the nominal specified sizes, which causes issues with the specific thickness bracket not mounting properly. Either the panel has to be sanded or routed to make it thinner or shims must be added to take up the loose fit of the bracket making it installable and properly functioning.

### BRIEF DESCRIPTION OF THE DRAWINGS

FIG. 1 illustrates a restraint bracket with a spring clip mounting element in accordance with an exemplary embodiment of the invention.

FIG. 2 illustrates a restraint bracket with a base for fastening to panel material in accordance with an exemplary embodiment of the invention.

FIG. 3 shows a cross section of a restraint bracket fastened to panel material, securing the panel material in a recessed opening in accordance with an exemplary embodiment of the invention.

FIGS. 4-6 show cross sections of a restraint bracket mounted by a spring clip to the edge of various panel materials for securing the material in a recessed opening in accordance with an exemplary embodiment of the invention.

FIG. 7 shows a perspective view of a restraint bracket mounted to the edge of panel material secured in a recessed opening of a structure in accordance with an exemplary embodiment of the invention.

FIG. 8 shows a close-up of a restraint bracket fastened to panel material, securing the material in a recessed opening of a structure in accordance with an exemplary embodiment of the invention.

### DETAILED DESCRIPTION OF THE PREFERRED EMBODIMENTS

The current innovation provides a restraint bracket for quickly and securely mounting planar materials between opposed substantially parallel surfaces in a removable, non-damaging manner. It is a generally universal bracket that non-intrusively secures and retains panel materials in the recessed openings of typical windows and doors.

The restraint bracket engages the jambs that frame the recessed opening. With a retaining edge that frictionally engages the openings surrounding wood, metal, stone, brick, stucco, etc., the friction engagement of the edge prevents penetrations to the moisture barrier and the subsequent required repair.

A universal mounting option allows consideration of lower-cost thinner materials in some openings without requiring the trouble of managing different mounting options. A user can also use sub-standard materials and non-standard sizes. One could even resort to securing windows and doors with scrap materials in an emergency where regular supplies may be short or difficult to reach.

In a typical application, a sheet of protective window covering (i.e. the panel material) is cut to fit in the recessed opening of a structure. The panel material may include, but is not limited to plywood, particle board, oriented strand board (OSB), polycarbonate, resin treated ballistic nylon, etc.

One or more restraint brackets are mounted to the edges of the panel material by the mounting element so that the holding flange of the restraint brackets extend beyond the edge of the panel material making it larger than then recessed window opening. The holding flanges are angled away from the outward surface of the panel material at an angle to the panel. surface.

As the panel material is forced into the recessed opening, the holding flanges are temporarily deformed (i.e. flexed outward) increasing the angle with the panel surface and reducing their projected distance beyond the panel edge. Once the panel is positioned in the recessed opening, in returning to their previous angle the holding flanges exert force against the jamb of the recessed opening. Friction holds the bracket restraining it against removal.

In an alternative embodiment, the retaining edge of the holding flange may be textured or serrated to increase the hold of the retaining edge of the restraining bracket. Though it may not be desired, it is preferred for a serrated edge to “bite” into the jamb causing minor damage instead of a complete loss of protection for the opening.

In one embodiment, the holding element of the restraint brackets mount to the panel material by fasteners inserted into the material through at least two openings in a base flange attached at an angle to the holding flange and supporting the holding flange at an angle to the panel surface.

In another embodiment, the holding element of the restraint brackets mount to the panel material by a spring clip secured to the edge of the panel material. The end of the holding flange opposite the retaining edge mates with a clip at an angle to the panel surface.

The clip is formed by a front and back side and a common base between the front and back side. The sides, angling toward each other at the end away from the base. By slipping the clip onto the edge of the panel material, the sides are forced apart, their springing bias exerting holding forces to secure the panel there between them.

In one embodiment, the sides may have one or more fastener holes to further securing the clips once applied to the panel, preventing any movement along the edge of the panel. In another embodiment, the base of the spring clip has a fastener opening, or projecting teeth from a relief cut that is bent inward to bite into the side of the panel material.

Clips are preferably made from strong durable springing metal or plastic material and have a strong closing force. To aid in application, the back side of the spring clip extends further than the front side/holding flange joint, and the back side has a tongue curving away from the front of the clip. This allows the tongue to catch the edge of the panel, and a bending force to be applied to the retaining edge forcing open the spring clip so it can be engaged with the edge of the panel material.

The preferred innovation described is sized to accommodate the standard choices of panel materials, plywood ranging from ⅜-inch to ¾-inch but could accommodate ¼-inch to ⅞-inch panels. One skilled in the arts would appreciate that the same design could be applied to other thickness and materials.

It should be apparent that the same concept can be used to secure linear material (dimensional lumber) such as 1×4 or 2×4 boards in a similar fashion by cutting them to span an opening between parallel faces. This can provide extra protection for reinforcing doors or holding panel materials not otherwise secured in the opening by the edges as described above.

The springing nature of the spring clip assures the proper grip of a restraining bracket to a range of material thicknesses. The upper end of the range is generally designate by the width of the base between the front and back sides. The lower end of the range is determined by the holding strength of the sides.

The embodiment having the base flange secured to the panel by fasteners works on any thickness of material. In this manner, the restraint bracket is universal, and mounts to any thickness of panel to apply to any circumstance.

By installing a plurality of restraint brackets to the edges of the panel, the panel may slide into place in the recessed opening. The retaining edges then provide enough holding force to prevent the panel from coming out of the window opening under storm or hurricane force winds.

In order to remove the panel, it is necessary to unseat the retaining edge of the bracket from the side of the recessed opening by using a finger or tool. An opening or cutout may be provided in the holding flange of the bracket for this purpose.

Once the holding flange has a counter force or is pried away from the jamb of the recessed opening, reducing the holding friction, the panel can be removed from the window opening by pulling on it. The spring clip brackets then slip off the panel edges easily and can be reused.

### DETAILED DESCRIPTION OF THE DRAWINGS

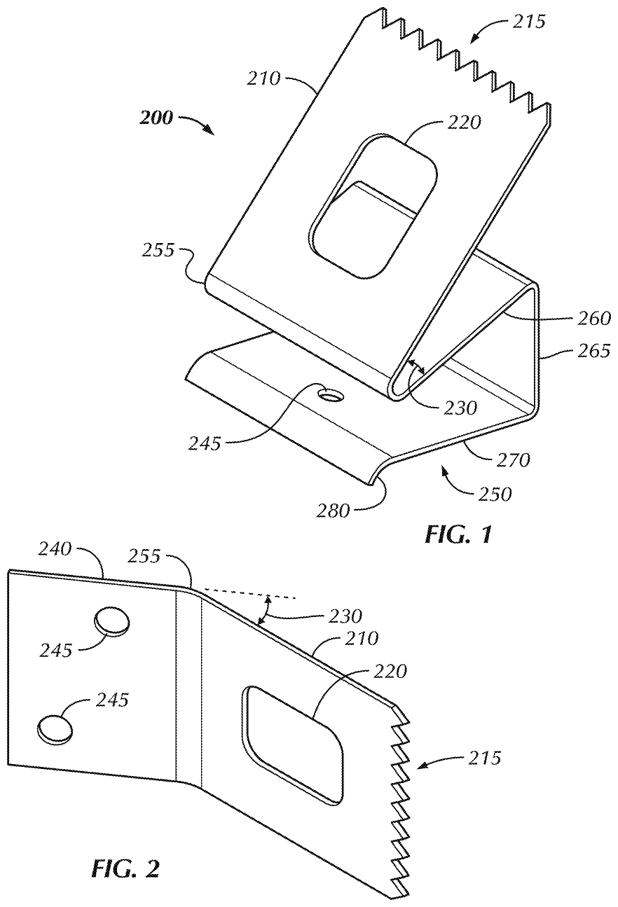

FIG. 1 illustrates a restraint bracket with a spring clip mounting element in accordance with an exemplary embodiment of the invention. The restraint bracket (200) is comprised of a holding flange (210) secured at an angle (255) to the front side (260) of the spring clip (250) so that when installed, the holding flange (210) is angled away (230) from the panel material's (not shown) outward facing surface. The holding flange (210) has a retaining edge (215) which may be serrated.

The holding flange (210) may be further comprised of a pry/release opening (220) for securing a tool while counteracting the force of the retaining edge (215) returning to the minimum. angle (230) through the spring bias of the force angle (255) joining the holding flange (210) to the front side (260) of the spring clip (250).

The spring clip (250) is comprised of a front side (260), jointed to the holding flange (210). The spring clip is generally U-shaped and wraps around the panel material (not shown) to secure the clip thereto. The front side (260) of the spring clip (250) is oriented to engage the outward face of the panel material, and joins to the base (265) of the spring clip (250) at an angle to substantially align the base (265) along the side of the panel material extending between its to faces.

The base (265) joins the back side (270) of the spring clip (250) at an angle to substantially align the back side (270) parallel to and engaging the inward face of the panel material. The end of the back side (270) opposite the base (265) of the spring clip (250) is curved outward in a tongue (280) to assist mounting.

The back side (270) preferably extends farther from the base (265) than the front side (260) to ease engaging the tongue (280) against the panel material's edge for installation. A fastener opening (245) may be present in any of the sides (260 & 270) or base (265) of the spring clip (250) for fastening to the panel material.

FIG. 2 illustrates a restraint bracket with a base for fastening to panel material in accordance with an exemplary embodiment of the invention. The restraint bracket (200′) is comprised of a holding flange (210) secured at an angle (255) to a base flange (240) so that when install, the holding flange (210) is angled away (230) from the panel material's (not shown) outward facing surface. The holding flange (210) has a retaining edge (215) which may be serrated.

The holding flange (210) may be further comprised of a pry/release opening (220) for securing a tool while counteracting the force of the retaining edge (215) returning to the minimum angle (230) through the spring bias of the force angle (255) joining the holding flange (210) to the base flange (240).

The base flange (240) is mounted parallel to the outward surface of the panel material and oriented so the holding flange (210) is projecting outward from the outward face and extends past the edge of the panel material. A plurality of fastener openings (245) secure the base flange (240) preventing movement of the restraint bracket (200) in relation to the panel material edge.

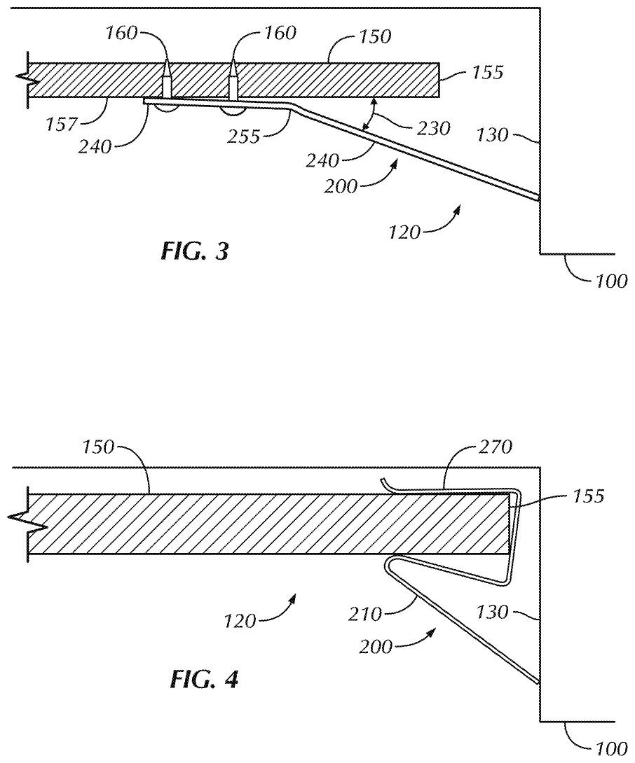

FIG. 3 shows a cross section of a restraint bracket fastened to panel material, securing the panel material in a recessed opening in accordance with an exemplary embodiment of the invention. The restraint bracket (200) is mounted to the outward face (157) of the panel material (150) by a plurality of fasteners (160) passing through the openings (245, not labeled) in the base flange (240).

The force angle (255) at the joint between the base flange (240) and the holding flange (210) of the restraint bracket (200) orients the holding flange (210) away from the outward face (157) of the panel material (150) at a minimum angle (230) so that the retaining edge (215, not labeled), extending beyond the edge (155) of the panel material (150) exerts a force against the jamb (130) of the recessed opening (120) in the structure (100).

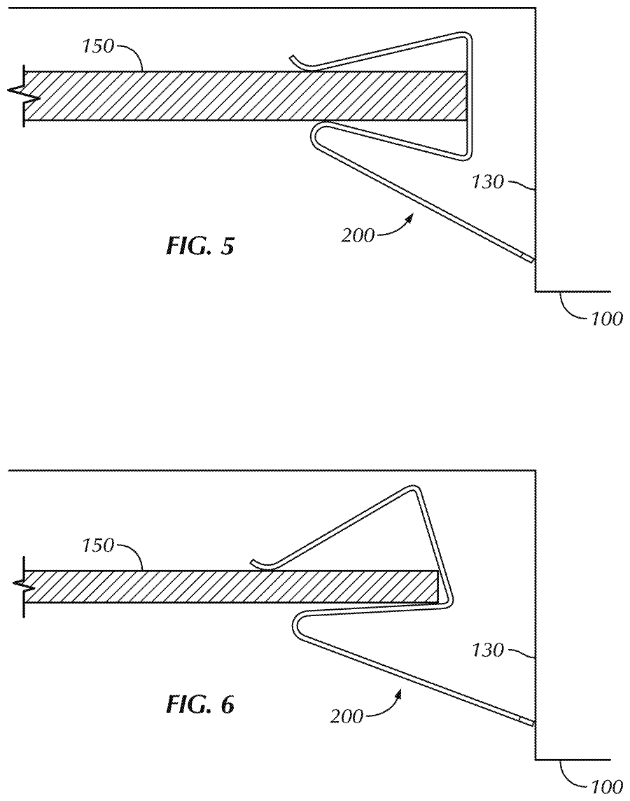

FIGS. 4-6 show cross sections of a restraint bracket mounted by a spring clip to the edge of various panel materials for securing the material in a recessed opening in accordance with an exemplary embodiment of the invention. The restraint bracket (200) is secured to the edge (155) of panel material (150).

Different orientations may occur as illustrated, but in each the spring clip (250) holds to the edge (155) of the panel material (150). The holding flange always extends past the edge (155) so that forcing the panel material (150) into the recessed opening (120) provides the holding force against the frame or jamb (130) of the structure (100).

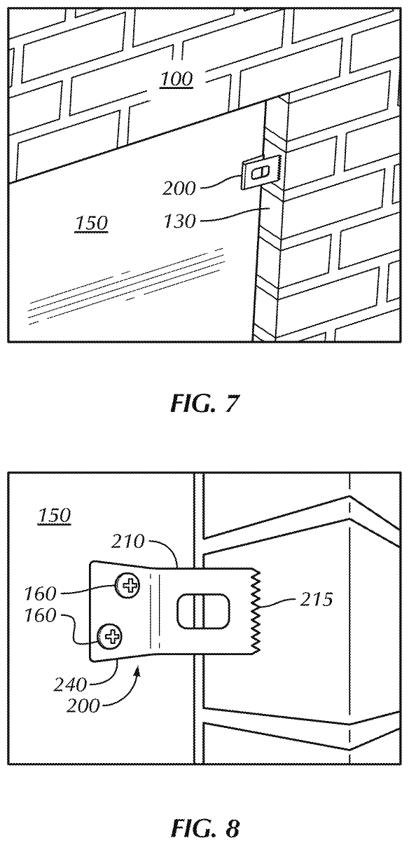

FIG. 7 shows a perspective view of a restraint bracket mounted to the edge of panel material secured in a recessed opening of a structure in accordance with an exemplary embodiment of the invention. The restraint bracket (200) secured to the edge of panel material (150) is secured in a recessed opening by the force of the retaining edge (21.5) against the jamb (130) of the structure (100).

FIG. 8 shows a close-up of a restraint bracket fastened to panel material, securing the material in a recessed opening of a structure in accordance with an exemplary embodiment of the invention. The restraint bracket (200) is secured by fasteners (160) through the base flange (240) so the holding flange (210) is angled away from the outward face of the panel material (150) with the retaining edge (215) engaging the jamb (130, not labeled) of the structure's (100, not labeled) recessed opening (120, not labeled).

Diagrams in accordance with exemplary embodiments of the present invention are provided as examples and should not be construed to limit other embodiments within. the scope of the invention. For instance, heights, widths, and thicknesses may not be to scale and should not be construed to limit the invention to the particular proportions illustrated.

Some elements illustrated in the singularity may actually be implemented in a plurality. Some element illustrated in the plurality may vary in count from that shown. Specific numerical data values or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A restraint bracket for temporarily attaching panel material in a recessed opening of a structure comprising:
a mounting element for securing the bracket to an edge of the panel material, and
a holding flange, the holding flange comprising:
a retaining edge for frictionally engaging a jamb of the recessed opening,
the retaining edge extending past the edge and angled away from the outward face of the panel material.

2. The restraint bracket as described in claim 1 wherein the mounting element comprises:
a base flange extending from the holding flange distal the retaining edge, and angled substantially parallel to the outward face of the panel material,
the base flange further comprising a plurality of openings for fasteners fixing the bracket to the panel material.

3. The restraint bracket as described in claim 1 wherein the mounting element comprises:
a spring clip for securing to the edge of panel material, comprising:
a front side and a back side extending up from a common base,
the front and back biased toward one another at a clamping end distal to the base,
the clamping end of the front side joining the holding flange at an acute angle.

4. The restraint bracket as described in claim 3 wherein the width of the base of the spring clip between the sides determines the maximum thickness of the panel material.

5. The restraint bracket as described in claim 3 wherein the distance between the clamping ends of the sides of the spring clip determines the minimum thickness of the panel material.

6. The restraint bracket as described in claim 1 wherein the retaining edge of the holding flange is serrated.

7. The restraint bracket as described in claim 1 wherein the holding flange further comprises a pry/release opening.

8. The restraint bracket as described in claim 3 wherein the bracket is of a metallic material.

9. The restraint bracket as described in claim 3 wherein the bracket is of a plastic material.

10. The restraint bracket as described in claim 3, the at least one of the sides of the spring clip further comprises one or more openings for fasteners to affix the bracket to the panel material.

11. The restraint bracket as described in claim 3, the base of the spring clip further comprising one or more openings for fasteners fixing the bracket to the panel material.

12. The restraint bracket as described in claim 3, the back side of the spring clip further comprising a guiding tongue curving away from the front side at the end distal the base.

13. The restraint bracket as described in claim 3, wherein the back side of the spring clip is longer than the front side and extends past the holding flange end adjoining the front side of the spring clip.

14. A method of temporarily securing panel material in a recessed opening of a structure comprising:
having panel material smaller than the recessed opening; and
one or more restraint brackets comprising:
a mounting element, and
a holding flange, the holding flange comprising:
a retaining edge for frictionally engaging a jamb of the recessed opening;
securing the restraint brackets to edges of the panel material, wherein the retaining edge extending past the edges and angled away from the outward face of the panel material, and extends the panel to larger than the recessed opening,
pushing the panel material into the recessed opening, the holding flanges of the one or more restraint brackets, engaging and exerting a force toward the jamb to secure the panel material therein.

15. The method as described in claim 14 wherein the holding flange further comprises a pry/release opening.

16. The method as described in claim 15 further comprising:
inserting a level into the pry/release opening,
exerting a counter force to disengage the retaining edge from the jamb, and
removing the panel material from the recessed opening.

17. The method as described in claim 14 wherein the mounting element of the restraining bracket comprises:
a base flange extending from the holding flange distal the retaining edge, and angled substantially parallel to the outward face of the panel material,
the base flange further comprising a plurality of openings for fasteners fixing the bracket to the panel material; and
securing the restraint brackets to edges of the panel material comprises affixing fasteners through the plurality of openings on the base flange.

18. The method as described in claim 17 further comprising:
at least partially removing the fasteners from the panel material releasing the force,
disengage the retaining edge from the jamb, and
removing the panel material from the recessed opening.
